(19) United States
(12) Patent Application Publication
(10) Pub. No.: US 2008/0039047 A1
(43) Pub. Date: Feb. 14, 2008

(54) Reception system

(75) Inventor: Shinpei Kubota, Amagasaki-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/878,566

(22) Filed: Jul. 25, 2007

(30) Foreign Application Priority Data
Aug. 9, 2006 (JP) 2006-217407

(51) Int. Cl. H04N 5/44; H04B 1/18; H04N 5/52; H04N 7/10

(52) U.S. Cl. 455/343.1

(57) ABSTRACT

The reception system of the present invention includes a detection circuit serving as detecting means for detecting that the strength of the receiver signal is equal to or greater than a predetermined value, and a resetting circuit serving as resetting means for, under instruction of the detection circuit, immediately increasing power consumption of the reception section when the detection circuit detects a large signal so as to bring back the state where the reception system ensures the greatest power consumption amount for the entire system and the sufficiently-desirable system performance.

Consequently, this invention provides an effect of reducing power consumption amount of the entire system, and an effect of stable reception by preventing reception failure even when a large interfering signal is suddenly supplied due to a change in peripheral radio wave condition.

This Nonprovisional application claims priority under 35 U.S.C. § 119(a) on Patent Application No. 2006/217407 filed in Japan on Aug. 9, 2006, the entire contents of which are hereby incorporated by reference.

### FIELD OF THE INVENTION

The present invention relates to a reception system used for a tuner device serving to receive radio waves, such as a TV tuner, particularly to a reception system consuming less power on reception.

### BACKGROUND OF THE INVENTION

An example of conventional power saving reception system used for a tuner device for receiving radio waves such as a TV tuner can be found in Patent Document 1 (Japanese Unexamined Patent Publication Tokukai 2002-252811 (published on Sep. 6, 2002)).

With reference to FIG. 4, the following explains a mechanism for reducing power consumption amount in a conventional reception system.

The conventional reception system includes, as a reception section, an amplifier 401, mixer 402, lowpass filter 403, and a variable gain amplifier 404. This reception system also includes a monitor circuit 405 as monitoring means, and a control circuit 406 as controlling means. Among these, the amplifier 401, the mixer 402, the lowpass filter 403, and the variable gain amplifier 404 are capable of changing power consumption.

In FIG. 4, a RF signal (Radio Frequency signal) supplied from an input terminal of the reception system (the preceding stage of the amplifier 401; not shown in the figure) is first sent to the reception section. In the reception section, the RF signal is first amplified by the amplifier 401. Then, the RF signal amplified by the amplifier 401 is mixed with a local oscillation component by the mixer 402, and is subjected to frequency conversion to be a IF signal (Intermediate Frequency signal). Then, the IF signal resulted from the frequency conversion is further processed by the lowpass filter 403 so that all unwanted signals other than a signal in a desired frequency range are removed. The signal is also adjusted by the variable gain amplifier 404 to a level most appropriate to reception.

After that, the IF signal output generated by the reception section is supplied to the monitor circuit 405.

In the reception system shown in FIG. 4, as described, the amplifier 401, the mixer 402, the lowpass filter 403, and the variable gain amplifier 404 in the reception section are all capable of changing power consumption. In such circuits, the performance and power consumption generally have a trade-off relationship. More specifically, the performance of the circuit is a positive function of the power consumption of the circuit. Accordingly, the reception performance of the system is a positive function of the power consumption amount of the entire system; that is, reduction in power consumption amount of the entire system results in degradation of the reception performance of the system.

In view of this, when receiving the IF signal output from the reception section, the monitor circuit 405 measures the reception performance of the system according to the received IF signal, and compares the measurement result with a predetermined set value. In this case, a bit error rate (“BER”, hereinafter) of the receiver signal or a noise/intermodulation product ratio (C/N of the receiver signal, hereinafter) of the receiver signal is used as a scale for measuring the reception performance of the system.

If the measurement result of the reception performance of the system given by the monitor circuit 405 is better than the predetermined value, more specifically, if the value is smaller than the predetermined value in the case of BER, or if the value is greater than the predetermined value in the case of C/N of the receiver signal, the monitor circuit 405 transmits to the control circuit 406 an order to reduce the power consumption amount of the entire system. Receiving this order, the control circuit 406 reduces power consumption of one of the amplifier 401, the mixer 402, the lowpass filter 403, and the variable gain amplifier 404.

Consequently, power consumption amount of the entire system decreases. As a result, the reception performance of the system also decreases.

Thereafter, the monitor circuit 405 measures again the reception performance of the system thus modified by the power consumption amount. The measured value is compared with the predetermined value and the power consumption of the reception section is adjusted accordingly.

By repeating this series of operations, the power consumption amount may be adjusted according to the periphery electric wave condition. Consequently, long-term power reduction can be attained.

However, in the conventional structure, if an interfering signal of a great strength is suddenly supplied to the reception system due to a change in peripheral radio wave condition, it takes a while to recover the reception system, and the reception has to be stopped until the system is recovered.

As a concrete example, the following discusses the case where the reception system, such as the one shown in FIG. 4, is used for a wireless mobile communication terminal or the like which may be used under a circumstance with a rapid change in peripheral radio wave condition; more specifically, under a circumstance where an interfering signal of a great strength may be suddenly supplied to the reception system.

As described, in the structure of FIG. 4, BER or C/N of the receiver signal is used as the reception performance value of the system, which serves as the reference value in controlling of power consumption amount of the entire system. However, the system needs to keep receiving signals for a certain period of time to obtain these parameters, and therefore it takes about several msec to several sec before the monitor circuit can measure an accurate value.

When an interfering signal of a great strength is suddenly supplied to the reception system due to a change, the C/N of the receiver signal or BER become rapidly worse, and the reception performance of the system excessively degrades. At this time, the control circuit 406 increases the power consumption of the entire system, in order to recover the reception performance of the system.

As described, it takes about several msec to several sec before the monitor circuit can measure an accurate value of the rapidly-changed BER or C/N of the receiver signal. However, the reception performance of the system keeps decreasing also in this period, and therefore there is a time lag between the supply of a large interfering signal and the increase in power consumption of the entire system by the control circuit 406.

Further, since the foregoing conventional structure successively controls the power consumption amount of the system with a predetermined increasing rate (the method of controlling the power consumption amount by a monitor circuit and a control circuit is described later), the reception system gradually recovers when a large interfering signal is suddenly supplied. Therefore, it takes a while to recover the system.

For this reason, before the control circuit 406 increases the power consumption of the entire system after a large interfering signal is supplied, the reception performance falls below the level required for the reception of the target RF signals. Consequently, this brings failure of signal reception.

### SUMMARY OF THE INVENTION

The present invention is made in view of the foregoing problems, and an object is to provide a reception system capable of reducing power consumption amount of the entire system and securely preventing such a reception failure period caused by sudden reception of a large interfering signal. The reception system of the present invention thus ensures stable reception.

In order to attain the foregoing object, the reception system according to the present invention comprises: a reception section for carrying out a receiving operation of a receiver signal wirelessly supplied, capable of varying power consumption: monitoring means for detecting reception performance of the receiver signal based on an output signal of the reception section; controlling means for controlling, as needed, power consumption of the reception section based on the reception performance of the receiver signal detected by the monitoring means; wherein the reception system is capable of reducing power consumption amount on reception by controlling a power consumption amount of the reception section according to the reception performance of the receiver signal so that performance of the reception system is constantly kept close to an allowable level, the reception system further comprising: detecting means for detecting that a strength of the receiver signal reaches or exceeds a predetermined value; and resetting means for increasing power consumption of the reception section so as to recover the reception performance of the reception section to a predetermined level when the detecting means detects that a strength of the receiver signal reaches or exceeds a predetermined value.

With this invention, the detecting means detects a strength of a receiver signal supplied wirelessly to the reception system, and the resetting means immediately increases power consumption of the reception section so as to recover the reception performance of the reception section to a predetermined level when the detecting means detects that a strength of the receiver signal reaches or exceeds a predetermined value. More specifically, the predetermined level designates a state where the power consumption amount of the entire reception system is sufficient to maintain stable reception operation of the receiver signal even in the reception of interfering signals, and also a desirable reception performance is ensured. Consequently, this invention provides an effect of reducing power consumption amount of the entire system, and an effect of stable reception by preventing reception failure even when a large interfering signal is suddenly supplied due to a change in peripheral radio wave condition.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a circuit block diagram showing a structure example of a reception system according to one embodiment of the present invention.

FIG. 2 is a circuit block diagram showing a structure example of a reception system according to another embodiment of the present invention.

FIG. 3 is a circuit block diagram showing a structure example of a reception system according to another embodiment of the present invention.

FIG. 4 is a circuit block diagram showing a structure of a conventional reception system.

### DESCRIPTION OF THE EMBODIMENTS

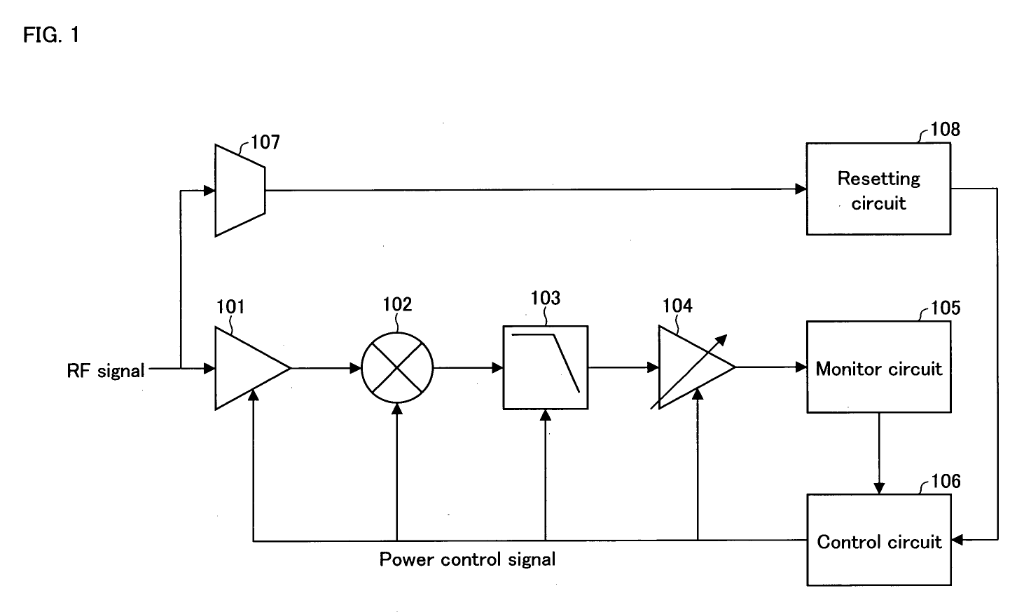

The following explains one embodiment of the present invention with reference to FIG. 1 to FIG. 3.

### First Embodiment

FIG. 1 shows a structure of reception system according to one embodiment of the present invention.

The reception system shown in FIG. 1 includes a reception section constituted of an amplifier 101, a mixer 102, a lowpass filter 103, and a variable gain amplifier 104; a monitor circuit 105 serving as monitoring means; a control circuit 106 serving as controlling means; a detection circuit 107 serving as detecting means; and a resetting circuit 108 serving as resetting means.

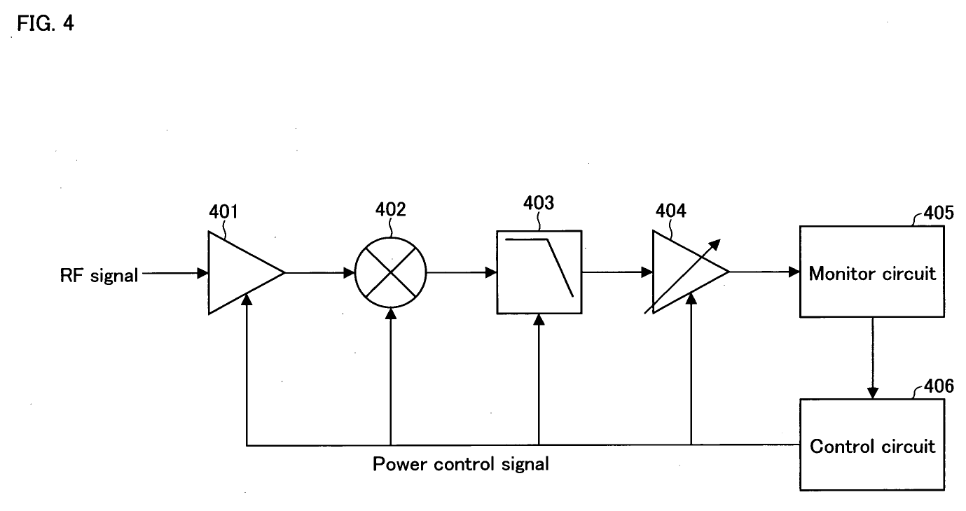

Among these, the amplifier 101, the mixer 102, the lowpass filter 103, and the variable gain amplifier 104 are capable of changing power consumption. These amplifier 101, mixer 102, lowpass filter 103, variable gain amplifier 104, monitor circuit 105, and control circuit 106 are all identical in structure to those of the reception system of FIG. 4.

From the input terminal (at a stage immediately before the amplifier 101; not shown in the figure), the detection circuit 107, the resetting circuit 108, and the control circuit 106 are connected in this order. As with the reception system of FIG. 4, also in FIG. 1, a RF signal supplied from the input terminal of the reception system is first sent to the reception section. In the reception section, the RF signal is first amplified by the amplifier 101. Then, the RF signal is subjected to frequency conversion by the mixer 102 to be a IF signal (Intermediate Frequency signal). The IF signal resulted from the frequency conversion is further processed by the lowpass filter 103 so that all unwanted signals other than a signal in a desired frequency range are removed. The signal is also adjusted by the variable gain amplifier 104 to a level most appropriate to reception. After that, the IF signal output generated by the reception section is supplied to the monitor circuit 105. The monitor circuit 105 measures the reception performance of the system according to BER or C/N or the received IF signal, and compares the measurement result with a predetermined set value. If the measurement result of the reception performance of the system given by the monitor circuit 105 is sufficiently superior to the predetermined value, the monitor circuit 105 causes the control circuit 106 to reduce power consumption of the entire system.

The control of power consumption of the entire system by the monitor circuit 105 and the control circuit 106 is carried out in the following manner, for example. First of all, when the monitor circuit 105 detects that the parameter indicating the reception performance such as a BER or a C/N is greater than the reference value (i.e. the reception performance is greater than an permissible performance level), the control circuit 106 gradually decreases the power consumption amount of the system by a predetermined decreasing rate. Then, when the monitor circuit 105 detects that the reception performance falls below the permissible performance level, the control circuit 106 stops reduction of power consumption. On the other hand, when the monitor circuit 105 detects that the parameter indicating the reception performance such as a BER or a C/N falls below the reference value (i.e. the reception performance falls bellow the permissible performance level), the foregoing process is inverted, i.e. the power consumption of the system is gradually increased by a predetermined increasing rate until the reception performance falls above the permissible performance level.

If fluctuation of reception condition is relatively gradual, such a control of power consumption amount by the monitor circuit 105 and the control circuit 106 keeps the reception performance of the reception system around the permissible level, and a large power consumption reduction effect is ensured. On the other hand, if a large interfering signal is suddenly supplied to the reception system, such an incremental control only allows the reception system to be recovered gradually, and it takes a while before the system is fully recovered. Therefore, the system has a problem of reception failure during this period.

The reception system according to the present embodiment includes the detection circuit 107 and the resetting circuit 108 as a constitution for immediately recovering the reception performance of the reception system when the reception performance of the reception system needs to be immediately recovered from a rapid decrease due to sudden reception of a large interfering signal other than the target RF signals.

The RF signal supplied to the input terminal of the reception system is also supplied to the detection circuit 107. Receiving the RF signal, the detection circuit 107 detects whether the strength of the RF signals greater than a predetermined value, and transmits this detection result to the resetting circuit 108.

In this process, any kind of means can be used for transmission of the information of detection result from the detection circuit 107 to the resetting circuit 108. A typical example is a method of using a logic signal for outputting a high level signal when the strength of the RF signal is greater than the predetermined value and outputting a low level signal when the strength of the RF signal is smaller than the predetermined value. In this case, a reference value is set in the detection circuit in advance as the predetermined value. Note that, detection of signal strength of the input RF signal by the detection circuit 107 may be carried out by detecting amplitude of the input RF signal waveform, for example. However, since appropriate magnitude of the predetermined value differs depending on the device to which the reception system of the present invention is mounted, and therefore the value should be determined in consideration of the assumed strength of the interfering signal by which the reception performance of the device decreases to be less than the desired level. The detection circuit 107 may be realized by any conventional detection circuit.

Note that, when such an interfering signal other than the RF signal reception system is supplied due to a change in periphery radio wave circumstance, the interfering signal is also supplied to the detection circuit 107.

When a high-level signal is received from the detection circuit 107 (that is, the strength of the input RF signal is greater than the predetermined value), the resetting circuit 108 immediately instructs the control circuit 106 to bring the condition back to a state having the greatest power consumption amount and the best system performance. More specifically, the predetermined value in the detection circuit 107 is so set as to output a high-level signal when the input interfering signal has a strength which will significantly decrease the reception condition of the desired signal.

Receiving the instruction, the control circuit 106 recovers the power consumption of the reception section, more specifically the power consumption of the amplifier 101, the mixer 102, the lowpass filter 103, and the variable gain amplifier 104, to a state having the greatest power consumption amount and the best system performance.

As such, in the case where the system suddenly receives a large interfering signal other than the desired input RF signals, the foregoing invention rapidly increases the reception performance of the system to a value not causing any defect in the reception operation (in the present embodiment, to a state having the greatest power consumption in the entire system and the best system performance). On this account, the defect on the sudden reception of a large interfering signal due to a change in peripheral radio wave condition can be prevented. The time taken for detection circuit 107 to recover the power consumption of the circuit operation section to the greatest value since detection of a signal with a significantly large strength is mush shorter than the time for gradually recovering the power consumption by measuring the BER or C/N of the receiver signal.

Therefore, this invention more efficiently reduces power consumption amount of the entire system, and ensures stable reception by preventing reception failure even when a large interfering signal is suddenly supplied due to a change in peripheral radio wave condition.

### Second Embodiment

In the First Embodiment, the detection circuit 107 outputs a high-level signal when the strength of the input RF signal is greater than the predetermined value. Receiving the high-level signal, the resetting circuit 108 determines that an interfering signal is supplied, and resets the system condition (to a state ensuring high reception performance).

However, in actual operation, the detection circuit 107 detects a high-level signal not only when the interfering signal is supplied but also when the target RF signal has a large strength. If the output of the high-level signal is caused by input of a RF signal having a large strength, resetting the system causes an unwanted increase in power consumption of the system. In view of this problem, the present embodiment and the later-described third embodiment describe a further improved structure of differentiating input of interfering signal and input of RF signal having a large strength, and resetting the system only on the input of interfering signal.

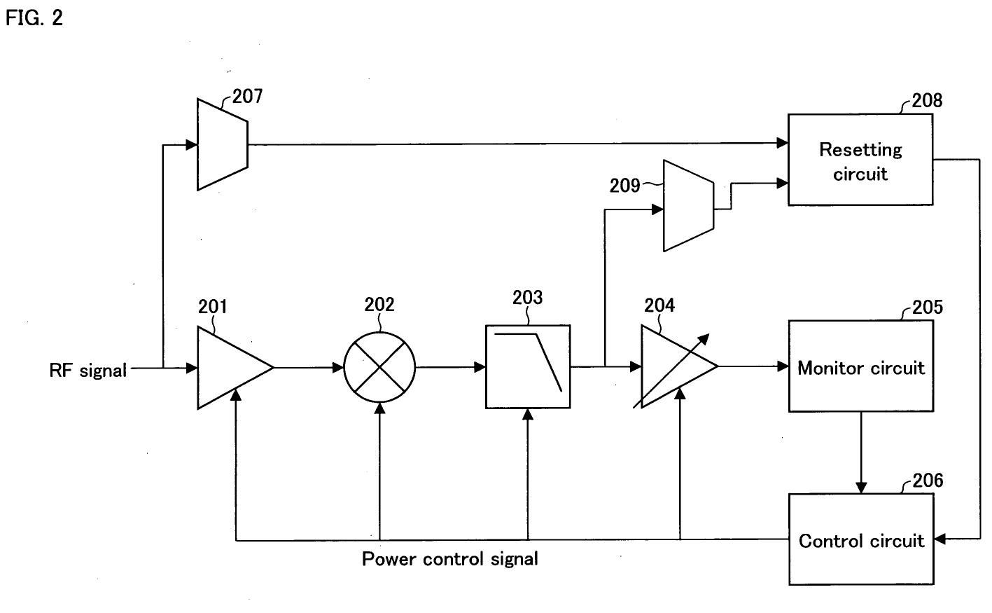

FIG. 2 shows a structure of a reception system according to another embodiment of the present invention.

The reception system shown in FIG. 2 includes an amplifier 201, a mixer 202, a lowpass filter 203, and a variable gain amplifier 204 which constitute a reception section; a monitor circuit 205 serving as monitoring means; a control circuit 206 serving as controlling means; a first detection circuit 207 and a second detection circuit 209 serving as detecting means; and a resetting circuit 208 serving as resetting means.

Among these, the amplifier 201, the mixer 202, the lowpass filter 203, and the variable gain amplifier 204 are capable of changing power consumption. These amplifier 201, the mixer 202, the lowpass filter 203, the variable gain amplifier 204, the monitor circuit 205, and the control circuit 206 are all identical in structure to those of the reception system of FIG. 4.

From the input terminal (at a stage immediately before the amplifier 201; not shown in the figure), the first detection circuit 207, the resetting circuit 208, and the control circuit 206 are connected in this order. The second detection circuit 209 is connected between the following stage of the lowpass filter 203 (i.e. between the lowpass filter 203 and the variable gain amplifier 204) and the resetting circuit 208. The second detection circuit 209 outputs a detection result of the output from the lowpass filter 203 to the resetting circuit 208.

In FIG. 2, the RF signal supplied from the input terminal of the reception system is sequentially processed by the amplifier 201, the mixer 202, the lowpass filter 203, the variable gain amplifier 204, the monitor circuit 205, and the control circuit 206 in the same manner as that of FIG. 4. When the system performance is regarded superior than the predetermined value, the control circuit 206 decreases the power consumption amount of the entire system.

The RF signal supplied to the input terminal of the reception system is also supplied to the first detection circuit 207. Further, the IF signal output without the signal other than the reception band is supplied to the second detection circuit. The first detection circuit 207 and the second detection circuit 209 output a high-level signal when the input signal has a strength larger than the predetermined value, and output a low-level signal when the input signal has a strength smaller than the predetermined value. Note that, the first detection circuit 207 and the second detection circuit 209 each may be realized by the same circuit as that of the detection circuit 107 of First Embodiment. However, the value set in the first detection circuit 207 is not always equal to the value set in the second detection circuit 209.

Further, the resetting circuit 208 receives detection information from the first detection circuit 207 and detection information from the second detection circuit 209.

Note that, when such an interfering signal other than the RF signal reception system is supplied due to a change in periphery radio wave circumstance, the interfering signal is also supplied to the detection circuit 207.

The second detection circuit 209 receives a signal having been through the lowpass filter 203 where all unwanted signals other than a signal in a desired frequency range are removed.

Since the signal removal is not performed for the target RF signal having a large strength, the second detection circuit 209 outputs a high-level signal as with the first detection circuit 207. On the other hand, when a high-strength interfering signal of a different channel is supplied, interfering wave components are sufficiently removed by the lowpass filter 203. Since the strength of the receiver signal significantly decreases after the signal is processed by the filter circuit, the second detection circuit 209 outputs a low level signal.

Accordingly, if the first detection circuit 207 outputs a high-level and the second detection circuit 209 outputs a low-level, it indicates that a large-strength interfering signal is supplied into the reception system, in other words, it indicates that the reception performance of the system needs to be recovered.

Therefore, when receiving a high-level signal from the first detection circuit 207 and receiving a low level signal from the second detection circuit 209, the resetting circuit 208 immediately instructs the control circuit 206 to recover the power consumption amount of the system so that the system ensures the greatest power consumption amount and the best system performance.

Receiving the instruction, the control circuit 206 recovers the power consumption of the reception section, more specifically the power consumption of the amplifier 201, the mixer 202, the lowpass filter 203, and the variable gain amplifier 204, to a state having the greatest power consumption amount and the best system performance.

With this structure, the reception system of the present embodiment differentiates input of interfering signal and input of RF signal having a large strength. Therefore, this invention more efficiently reduces power consumption amount of the entire system, and ensures stable reception by preventing reception failure even when a large interfering signal is suddenly supplied due to a change in peripheral radio wave condition. In addition to this, the present invention also more efficiently reduces the power consumption of the entire system.

### Third Embodiment

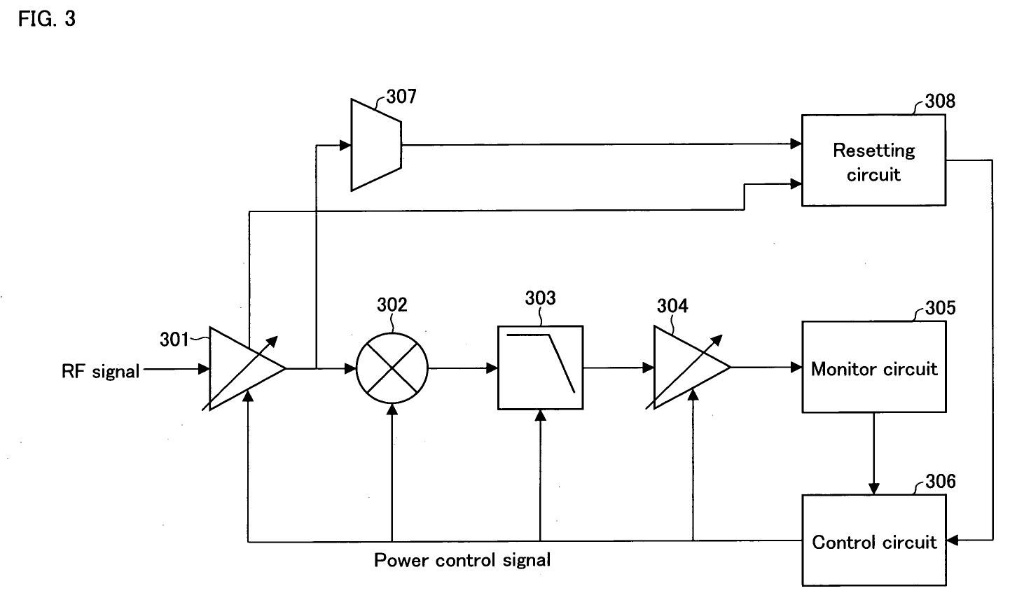

FIG. 3 shows a reception system according to still another embodiment of the present invention.

The reception system shown in FIG. 3 includes a variable gain amplifier 301, a mixer 302, a lowpass filter 303, and another variable gain amplifier 304 which constitute a reception section; a monitor circuit 305 serving as monitoring means; a control circuit 306 serving as controlling means; a detection circuit 307 serving as detecting means; and a resetting circuit 308 serving as resetting means. The variable gain amplifier 301 adjusts an RF signal supplied from the input terminal to a level suitable for frequency conversion, which is carried out in the mixer 302, before outputting the RF signal to the mixer 302. Among these, the variable gain amplifier 301, the mixer 302, the lowpass filter 303, and the variable gain amplifier 304 are capable of changing power consumption. These mixer 302, lowpass filter 303, variable gain amplifier 304, monitor circuit 305, and control circuit 306 are all identical in structure to those of the reception system of FIG. 4. From the following stage of the variable gain amplifier 301 (i.e. between the variable gain amplifier 301 and the mixer 302), the detection circuit 307, the resetting circuit 308, and the control circuit 306 are connected in this order. The variable gain amplifier 301 outputs information showing its own gain to the resetting circuit 308.

In FIG. 3, a RF signal supplied from the input terminal of the reception system is first amplified by the variable gain amplifier 301. Then, the RF signal is subjected to frequency conversion by the mixer 302 to be a IF signal. The IF signal resulted from the frequency conversion is further processed by the lowpass filter 303 so that all unwanted signals other than a signal in a desired frequency range are removed. The signal is also adjusted by the variable gain amplifier 304 to a level most appropriate for reception. After that, the IF signal is outputted to the monitor circuit 305. The monitor circuit 305 measures the reception performance of the system according to BER or C/N or the received IF signal, and compares the measurement result with a predetermined set value. If the measurement result of the reception performance of the system given by the monitor circuit 305 is sufficiently superior to the predetermined value, the monitor circuit 305 causes the control circuit 306 to reduce power consumption of the entire system.

The signal amplified by the variable gain amplifier 301 is also supplied to the detection circuit 307. The detection circuit 307 outputs a high-level signal when the input signal has a strength larger than the predetermined value, and outputs a low-level signal when the input signal has a strength smaller than the predetermined value. Note that, the detection circuit 307 may be realized by the same circuit as that of the detection circuit 107 of First Embodiment.

Further, the gain information of the variable gain amplifier 301 is directly supplied to the resetting circuit 308. The resetting circuit 308 receives the gain information of the variable gain amplifier 301, in addition to the detection information of the detection circuit 307.

Note that, the gain of the variable gain amplifier 301 is normally controlled by a voltage, and the control voltage and the gain of the amplifier have a relation of 1:1. More specifically, the gain information of the variable gain amplifier 301 is equal to the control voltage of the variable gain amplifier 301. Note that, the present embodiment assumes that the gain of the variable gain amplifier 301 is a positive function of the control voltage, and the resetting circuit 308 receives information of the control voltage of the variable gain amplifier 301. Further, the gain of the variable gain amplifier 301 and the gain of the variable gain amplifier 304 are controlled in consideration of the performance level measured by the monitor circuit 305 and some other conditions, by the control circuit 306 which resides in the following stage of the monitor circuit 305. This ensures gain distribution most useful for the system.

In the present embodiment, in the absence of an interfering signal, the gain of the variable gain amplifier 301 is small when the target RF signal has a large strength, and the gain of the variable gain amplifier 301 is large when the target RF signal has a small strength.

More specifically, when the target RF signal has a large strength, the detection circuit 307 outputs a high-level signal, and the control voltage of the variable gain amplifier 301 decreases. On the other hand, when the target RF signal has a small strength, the control voltage of the variable gain amplifier 301 increases, and the detection circuit 307 outputs a low level signal.

Note that, since the influence of the interfering signal is relatively small in this embodiment when the input target RF signal has a large strength, the following discusses only the case of receiving an interfering signal when the input target RF signal has a small strength.

When a large-strength interfering (different) signal is supplied under reception of small-strength RF signals, the strength of the signal supplied to the reception system increases, and therefore the detection circuit 307 outputs a high-level signal.

Further, as described, the control of the reception section by the monitor circuit 305 and the control circuit 306 is gradual, and it makes the gain of the variable gain amplifier 301 also change gradually. Immediately after the input of an interfering signal, the gain of the variable gain amplifier 301 is still large.

This result shows that the state where (i) the detection circuit 307 outputs a high-level and (ii) the gain level of the variable gain amplifier 301 is large indicates reception of a large-strength interfering (different) signal under reception of small-strength RF signals, more specifically, it indicates a situation requiring recovery of reception performance of the system.

Accordingly, when receiving a high-level signal from the detection circuit 307 and determining that the control voltage of the variable gain amplifier 301 is greater than a predetermined value, the resetting circuit 308 immediately instructs the control circuit 306 to recover the power consumption amount of the system so that the system ensures the greatest power consumption amount and the best system performance.

Receiving the instruction, the control circuit 306 recovers the power consumption of the reception section, more specifically, the power consumption of the variable gain amplifier 301, the mixer 302, the lowpass filter 303, and the variable gain amplifier 304, to a state having the greatest power consumption amount and the best system performance.

With this structure, the reception system of the present embodiment differentiates input of a large-strength interfering signal and input of a large-strength RF signal. Therefore, this invention more efficiently reduces power consumption amount of the entire system, and ensures stable reception by preventing reception failure even when a large interfering signal is suddenly supplied due to a change in peripheral radio wave condition. In addition to this, the present invention also more efficiently reduces the power consumption of the entire system.

Note that, in the respective embodiments above, all of the components constituting the reception section, namely the amplifier, the mixer, the lowpass filter, and the variable gain amplifier are capable of changing power consumption. However, in the case of constituting the reception system of the present invention with a plurality of functional blocks, the foregoing effect is ensured as long as at least one of the functional blocks is capable of changing power consumption.

Further, in the foregoing respective embodiments, the control circuit, which has received the instruction from the resetting circuit, recovers the power consumption of the reception section, more specifically, the power consumption of the variable gain amplifier, the mixer, the lowpass filter, and the variable gain amplifier, to a state having the greatest power consumption amount and the best system performance. However, the reception system of the present invention does not always ensure the foregoing best state when the control circuit recovers the reception performance. More specifically, the reception system according to the present invention at least recovers the power consumption amount of the entire system to a state ensuring a power consumption amount and a system performance sufficient to maintain stable reception operation of the receiver signal. On this account, stable reception of the target signals is ensued even in the reception of interfering signals.

The reception system according to the present invention is applicable to a tuner section of a device for receiving radio waves of receiver signals, such as a TV receiver device. The present invention is particularly useful for a wireless mobile communication device which is likely to experience sudden change in radio wave condition.

In order to attain the foregoing object, the reception system of the present invention comprises: a reception section for carrying out a receiving operation of a receiver signal wirelessly supplied, capable of varying power consumption: monitoring means for detecting reception performance of the receiver signal based on an output signal of the reception section; controlling means for controlling, as needed, power consumption of the reception section based on the reception performance of the receiver signal detected by the monitoring means; wherein the reception system is capable of reducing power consumption amount on reception by controlling a power consumption amount of the reception section according to the reception performance of the receiver signal so that performance of the reception system is constantly kept close to an allowable level, the reception system further comprising: detecting means for detecting that a strength of the receiver signal reaches or exceeds a predetermined value; and resetting means for increasing power consumption of the reception section so as to recover the reception performance of the reception section to a predetermined level when the detecting means detects that a strength of the receiver signal reaches or exceeds a predetermined value.

With this invention, the detecting means detects a strength of a receiver signal supplied wirelessly to the reception system, and the resetting means immediately increases power consumption of the reception section so as to recover the reception performance of the reception section to a predetermined level when the detecting means detects that a strength of the receiver signal reaches or exceeds a predetermined value. More specifically, the predetermined level designates a state where the power consumption amount of the entire reception system is sufficient to maintain stable reception operation of the receiver signal even in the reception of interfering signals, and also a desirable reception performance is ensured.

Consequently, this invention provides an effect of reducing power consumption amount of the entire system, and an effect of stable reception by preventing reception failure even when a large interfering signal is suddenly supplied due to a change in peripheral radio wave condition.

Note that, the reception system according to the present invention is preferably arranged so that the monitoring means detects the reception performance of the receiver signal based on a bit error rate of the output signal of the reception section.

Further, the reception system according to the present invention is preferably arranged so that the monitoring means detects the reception performance of the receiver signal based on a noise/intermodulation product ratio of the output signal of the reception section.

In order to attain the foregoing object, the reception system according to the present invention is arranged so that the reception section includes a filter circuit for removing all unwanted signals other than a signal in a reception band range from the receiver signal, and the detecting means includes a first detection circuit provided on at least one part between an input terminal and the filter circuit, and a second detection circuit provided on at least one part between the filter circuit and the monitoring means.

With this invention, the reception section includes a filter circuit for removing all unwanted signals other than a signal in a reception band range from the receiver signal, and the detecting means includes a first detection circuit for detecting an unprocessed receiver signal having been wirelessly supplied to the reception system, and a second detection circuit for detecting a receiver signal having been through the filter circuit where all unwanted signals other than a signal in a reception band range are removed. The first detection circuit and the second detection circuit output the same detection result when a high-strength target receiver signal is supplied. However, when a high-strength interfering signal of a different band is supplied, the filter circuit removes all unwanted signals other than a signal in a reception band range from the receiver signal, and the strength of the receiver signal having been through the filter circuit significantly decreases compared with that before going through the filter circuit. Therefore the first detection circuit and the second detection circuit output different results.

Consequently, the foregoing invention provides an effect of differentiating input of a high-strength interfering signal of a different frequency and input of a target RF signal having a large strength. Therefore, this invention provides an effect of more efficiently reducing power consumption on reception.

The reception system according to the present invention may be further arranged so that the reception section includes a variable gain amplifier capable of gain control and a detection circuit provided in a following stage of the variable gain amplifier, the resetting means is supplied with gain information of the variable gain amplifier and a detection result given by the detection circuit, and the resetting means increases power consumption of the reception section so as to recover the reception performance of the reception section to a predetermined level on condition that (i) the gain of the variable gain amplifier is equal to or greater than the predetermined level and (ii) the detection result shows that the strength of the receiver signal is equal to or greater than a predetermined value.

With this invention, the reception section includes a variable gain amplifier connected to in input terminal capable of gain control and a detection circuit provided in a following stage of the variable gain amplifier, and the resetting means is supplied with gain information of the variable gain amplifier and a detection result given by the detection circuit. The resetting means immediately increases power consumption of the reception section in the case where (i) the gain of the variable gain amplifier is equal to or greater than the predetermined level and (ii) the detection result shows that the strength of the receiver signal is equal to or greater than a predetermined value. The detection circuit outputs the same detection result when a high-strength target receiver signal is supplied, and when a high-strength interfering signal of a different band is supplied. However, the gain of variable gain amplifier differs. This structure differentiates input of a target RF signal having a large strength and input of a high-strength interfering signal, and suspends the resetting circuit on the input of a target RF signal having a large strength, and operates the resetting circuit on the input of a high-strength interfering signal, so as to bring back the state where the system ensures the greatest power consumption amount and the best system performance.

Consequently, the foregoing invention provides an effect of differentiating input of a target RF signal having a large strength and input of a high-strength interfering signal of a different frequency. Therefore, this invention provides an effect of more efficiently reducing power consumption on reception.

A device according to the present invention is a device for receiving a receiver signal wirelessly supplied, the device including the foregoing reception system as a tuner section.

With this invention, it is possible to realize a device including, as a tuner section, a reception system capable of bringing back a state where the reception system ensures the greatest power consumption amount for the entire system and the sufficiently-desirable system performance.

Consequently, this invention provides an effect of reducing power consumption amount of the entire system, and also preventing reception failure even when a large interfering signal is suddenly supplied due to a change in peripheral radio wave condition. The invention of the present embodiment thus provides an effect of stable reception.

The present invention is useful for a tuner device serving to receive radio waves, such as a TV tuner.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A reception system comprising: a reception section for carrying out a receiving operation of a receiver signal wirelessly supplied, capable of varying power consumption: monitoring means for detecting reception performance of the receiver signal based on an output signal of the reception section; controlling means for controlling, as needed, power consumption of the reception section based on the reception performance of the receiver signal detected by the monitoring means;
wherein:
the reception system is capable of reducing power consumption amount on reception by controlling a power consumption amount of the reception section according to the reception performance of the receiver signal so that performance of the reception system is constantly kept close to an allowable level,
the reception system further comprising:
detecting means for detecting that a strength of the receiver signal reaches or exceeds a predetermined value; and
resetting means for increasing power consumption of the reception section so as to recover the reception performance of the reception section to a predetermined level when the detecting means detects that a strength of the receiver signal reaches or exceeds a predetermined value.

2. The reception system as set forth in claim 1, wherein the monitoring means detects the reception performance of the receiver signal based on a bit error rate of the output signal of the reception section.

3. The reception system as set forth in claim 1, wherein the monitoring means detects the reception performance of the receiver signal based on a noise/intermodulation product ratio of the output signal of the reception section.

4. The reception system as set forth in claim 1, wherein the reception section includes a filter circuit for removing all unwanted signals other than a signal in a reception band range from the receiver signal, and the detecting means includes a first detection circuit provided on at least one part between an input terminal and the filter circuit, and a second detection circuit provided on at least one part between the filter circuit and the monitoring means.

5. The reception system as set forth in claim 1, wherein the reception section includes a variable gain amplifier capable of gain control and a detection circuit provided in a following stage of the variable gain amplifier, the resetting means is supplied with gain information of the variable gain amplifier and a detection result given by the detection circuit, and the resetting means increases power consumption of the reception section so as to recover the reception performance of the reception section to a predetermined level on condition that (i) the gain of the variable gain amplifier is equal to or greater than the predetermined level and (ii) the detection result shows that the strength of the receiver signal is equal to or greater than a predetermined value.

6. A device for receiving a receiver signal wirelessly supplied, the device including the reception system as set forth in claim 1 as a tuner section.
